(19) United States
(12) Patent Application Publication
(10) Pub. No.: US 2016/0177022 A1
(43) Pub. Date: Jun. 23, 2016

(54) CROSSLINKING COMPONENTS FOR ELECTROCOAT COMPOSITIONS, ELECTROCOAT COMPOSITIONS, AND PROCESSES FOR FORMING A LAYER OF AN ELECTROCOAT COMPOSITION ON A SURFACE OF A SUBSTRATE

(71) Applicant: AXALTA COATING SYSTEMS IP CO., LLC, Wilmington, DE (US)

(72) Inventor: Taddesse GEBREGIORGIS, Rochester, MI (US)

(21) Appl. No.: 14/575,585

(22) Filed: Dec. 18, 2014

(51) Int. Cl. C08G 18/76; C09D 163/00; C25D 9/02; C08G 18/32; C25D 3/02; C25D 5/50

(52) U.S. Cl. CPC C08G 18/7657; C25D 3/02; C25D 5/50; C25D 9/02; C08G 18/3215; C09D 163/00

(57) ABSTRACT

A crosslinking component for electrocoat compositions is provided. The crosslinking component contains a blocked polyisocyanate. The blocked polyisocyanate includes at least three blocked isocyanate groups. A blocking agent for the blocked polyisocyanate contains from about 25 to about 75 mol % alcohols (A) comprising 4 carbon atoms or less, and from about 25 to about 75 mol % alcohols (B) comprising 5 carbon atoms or more and containing one or more ether groups. An electrocoat composition containing the crosslinking component and a process for forming a layer of an electrocoat composition on a surface of a substrate also are provided.

### TECHNICAL FIELD

The technical field relates to a crosslinking component for electrocoat compositions, an electrocoat composition comprising such a crosslinking component, and a process for forming a layer of the electrocoat composition on the surface of a substrate. More particularly, the technical field relates to a crosslinking component containing a combination of alcohols as a blocking agent, an electrocoat composition comprising such a crosslinking component, and a process for forming a layer of the electrocoat composition on the surface of a substrate.

### BACKGROUND

Cathodic electrocoat compositions are very widely used in many industrial coating processes. The compositions provide high paint utilization rates, low environmental contamination and excellent corrosion resistance to metal substrates. Such coating compositions usually contain a blocked polyisocyanate as a cross-linker. Upon curing, i.e. crosslinking the coating composition, the blocking agent is removed. However, the resulting compounds containing the former blocking group, usually alcohols or amines, contribute to the bake-off loss of the compositions. The compositions used today have a bake-off loss of about 15 weight percent (wt. %) or more. However, a bake-off loss of about 10 wt. % or less is desirable. Other properties such as appearance, throwpower, etc. should at least be maintained or even further improved.

Accordingly, it is desirable to provide a crosslinking component for an electrocoat composition that significantly reduces the bake-off loss of the electrocoat composition. In addition, it is desirable to provide an electrocoat composition comprising such a crosslinking component. It also is desirable to provide a process for forming a layer of such an electrocoat composition on the surface of a substrate. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a crosslinking component for electrocoat compositions comprises a blocked polyisocyanate, the blocked polyisocyanate comprising at least three blocked isocyanate groups, wherein a blocking agent for the blocked polyisocyanate comprises:

from about 25 to about 75 mol % alcohols (A) comprising 4 carbon atoms or less;

and

from about 25 to about 75 mol % alcohols (B) comprising 5 carbon atoms or more and containing one or more ether groups.

In accordance with another exemplary embodiment, an electrocoat composition comprises:

i) the crosslinking component described above; and

ii) a binder resin.

In accordance with a further exemplary embodiment, a process for forming a layer of an electrocoat composition on a surface of a substrate comprises the steps of:

providing a bath of an electrocoat composition as described above;

at least partially contacting the substrate with the electrocoat composition;

passing an electrical current through the substrate and the bath to apply a layer of the electrocoat composition onto a surface of the substrate;

removing the substrate from the electrocoat composition;

rinsing the surface of the substrate with deionized water; and

heating the applied layer of the electrocoat composition to at least partially cure the layer of the electrocoat composition.

A substrate coated with the electrocoat composition according to this disclosure and an automotive substrate coated with the electrocoat composition according to this disclosure also are provided in accordance with exemplary embodiments.

In accordance with an exemplary embodiment, a mixture of alcohols for use as a blocking agent for a polyisocyanate comprises:

from about 25 to about 75 mol % alcohols (A) comprising 4 carbon atoms or less; and

from about 25 to about 75 mol % alcohols (B) comprising 5 carbon atoms or more and containing one or more ether groups.

### BRIEF DESCRIPTION OF DRAWINGS

FIG. 1 is a schematic illustration of a conventional assembly used in a throwpower test.

FIG. 2 is a front view of a cathode used in a throwpower test of the Examples herein, the front view showing generally the measuring points used for determining the film thicknesses of the electrocoat composition deposited thereon during the throwpower test.

### DETAILED DESCRIPTION

The invention will be explained in greater detail below.

It will be appreciated that certain features which are, for clarity, described above and below in the context of separate embodiments may also be provided in combination in a single embodiment. Conversely, various features that are, for brevity, described in the context of a single embodiment may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

The crosslinking component and the electrocoat composition as contemplated herein are explained in greater detail below.

It has been found that, by using a specific mixture of alcohols as a blocking agent for a polyisocyanate, the bake-off loss of an electrocoat composition comprising such a polyisocyanate in the crosslinking component is significantly reduced. Using a blocked polyisocyanate instead of a polyisocyanate containing free isocyanate groups is usually needed as, otherwise, the appearance of the coating is significantly reduced. Upon deblocking, i.e., removal of the blocking agent, the resulting isocyanate group reacts with a complementary function on the binder present in the electrocoat composition, usually an —OH-group, amine group, carboxylic acid group, etc.

Thus, the bake-off loss originates to a significant extent from the blocking agent used in the crosslinking component. It has been found that a specific combination of alcohols as blocking agent provides a crosslinking component having a viscosity in the range required for coating applications without negatively affecting other properties. Moreover, the throwpower of the electrocoat compositions comprising the crosslinking component contemplated herein is significantly improved.

One of the most important features of the electrodeposition coating process in automotive application is its ability to extend films of uniform film thickness into recessed areas, such as rocker panels and door interiors (complex car body). A coating which has the ability to coat highly recessed areas is said to have high throwing power. A method for determining throwpower is described in the Examples.

The crosslinking component for electrocoat compositions contemplated herein comprises a blocked polyisocyanate, the blocked polyisocyanate comprising at least three blocked isocyanate groups, whereby a blocking agent for the blocked polyisocyanate comprises:

from about 25 to about 75 mol % alcohols (A) comprising 4 carbon atoms or less; and

from about 25 to about 75 mol % alcohols (B) comprising 5 carbon atoms or more and containing one or more ether groups.

Usually the blocked polyisocyanate comprising at least three blocked isocyanate groups does not comprise more than 10 blocked isocyanate groups. In one embodiment the blocked polyisocyanate comprising at least three blocked isocyanate groups does not comprise more than seven blocked isocyanate groups.

Alcohols (A) and (B) may each be mixtures of alcohols, each alcohol fulfilling the requirement of (A) and (B), respectively, including the preferred embodiments thereof. In this case the amount of alcohols (A) and (B) including their preferred embodiments refer to the total amount of alcohols (A) and (B) present in the blocked polyisocyanate contemplated herein.

The blocking agent may comprise up to about 20 mol % of alcohols (C) being different from (A) and (B). In one embodiment the blocking agent consists of alcohols (A), (B) and (C). If present, alcohols (C), which are different from (A) and (B), are preferably present in amount of not more than about 15 mol %. In another embodiment the blocking agent does not comprise alcohols different from (A) and (B). Hence, the blocking agent consists of alcohols according to (A) and (B).

Preferably the blocking agent comprises, preferably consists of,

from about 35 to about 70 mol % alcohols (A); and

from about 30 to about 65 mol % alcohols (B).

In one embodiment the blocking agent comprises, preferably consists of,

from about 40 to about 60 mol % alcohols (A); and

from about 27 to about 47 mol % alcohols (B);

the remainder to 100 mol % being alcohols (C) different from (A) and (B).

In another embodiment the blocking agent comprises, preferably consists of,

from about 40 to about 60 mol % alcohols (A); and

from about 60 to about 40 mol % alcohols (B).

Alcohols (C), if present, are alcohols comprising 5 carbon atoms or more and are free of ether groups. Preferably the alcohols (C) comprise heteroatoms only in the form of one or more —OH-groups. In a preferred embodiment alcohols (C) comprise 15 carbon atoms or less, e.g., 10 carbon atoms or less or 8 carbon atoms or less. Trimethylolpropane is, for example, suitable as alcohol (C).

In the preferred embodiments of alcohols (C) the blocking agent does not comprise alcohols that comprise 5 carbon atoms or more and are free of ether groups except for the alcohols (C) according to the respective preferred embodiment. For example, in case alcohols (C) comprise heteroatoms only in the form of one or more —OH-groups, alcohols that comprise 5 carbon atoms or more and are free of ether groups but comprise heteroatoms in a form different from —OH-groups, e.g. amine groups, such an alcohol is not present in the cross-linking component contemplated herein.

Alcohols (A) are alcohols comprising 4 carbon atoms or less. Alcohols (A) may comprise heteroatoms besides the oxygen atom in the —OH-group, e.g. one or more additional —OH-groups. In an embodiment, alcohols (A) are free of ether groups. Preferably alcohols (A) are free of heteroatoms besides the oxygen atom in the only —OH-group.

Non-limiting examples of alcohols (A) include methanol, ethanol, isopropanol, n-propanol, n-butanol, tert-butanol, iso-butanol, sec-butanol and mixtures thereof. Preferred alcohols (A) are ethanol, isopropanol, n-propanol and mixtures thereof. In one embodiment alcohol (A) is ethanol.

Alcohols (B) are preferably according to the following formula (I):

HO—R¹—O—R² (I)

wherein

R¹ is a C₁ to C₄-hydrocarbylene group, preferably propylene, ethylene, e.g. ethylene;

R² is a C₁ to C₅₀-hydrocarbyl group, optionally containing heteroatoms, preferably a C₃ to C₃₅ hydrocarbyl group, optionally containing heteroatoms.

In case heteroatoms are present in R² these heteroatoms are preferably selected from O, N, S or P, preferably O or N, more preferably O. In case oxygen is present in R², oxygen is preferably at least present in the form of one or more ether and/or —OH-groups, more preferably is only present in the form of one or more ether and/or —OH-groups.

In case heteroatoms are present in R², preferably not more than 15 heteroatoms are present in R², more preferably not more than 10 heteroatoms are present in R².

Suitable alcohols (B) are, for example, mono- and/or poly-ethyleneglycolether of mono-di- or tri-alcohols, preferably mono- and/or polyethyleneglycolether of mono- or di-alcohols.

Particularly preferred as alcohols (B) are compounds according to the following formula (II):

HO—[CH₂—CH₂—O]ₙ—R³ (II)

wherein

R³ is a C₁ to C₄₀-hydrocarbyl group, optionally containing heteroatoms, preferably a C₂ to C₂₅ hydrocarbyl group, optionally containing heteroatoms; and

n is 1 to 10, preferably 1 to 6, more preferably 1 to 4, e.g. 2 or 3.

More preferred as alcohols (B) are alcohols according to the following formulas (III), (IV) or mixtures thereof

HO—[CH₂—CH₂—O]ₘR⁴ (III)

wherein

R⁴ is a C₁ to C₁₀-hydrocarbyl group free of heteroatoms, preferably a C₂ to C₆ hydrocarbylene group free of heteroatoms, e.g. propyl, butyl, pentyl or isomers thereof, e.g. butyl or isomers thereof; and

m is 1 to 10, preferably 1 to 6, more preferably 1 to 4, e.g. 2;

HO—[CH₂—CH₂—O]ₒ—R⁵—[O—CH₂—CH₂]ₚ—OH (IV)

wherein

R⁵ is a C₆ to C₂₅-hydrocarbylene group free of heteroatoms, preferably a C₁₀ to C₂₀ hydrocarbyl group free of heteroatoms; and

o is 1 to 10, preferably 1 to 6, more preferably 2 to 4, e.g. 3; and

p is 1 to 10, preferably 1 to 6, more preferably 2 to 4, e.g. 3.

Even more preferably alcohols (B) are selected from compounds according to formula (III) as defined above, from compounds according to the following formula (V), or mixtures thereof

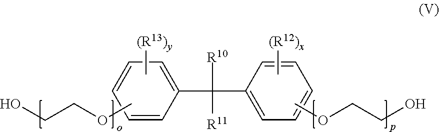

wherein

R¹³ and R¹⁴ are each independently selected from C₁ to C₄ hydrocarbyl groups, e.g. C₁ to C₄ alkyl groups such as methyl, ethyl, preferably methyl;

x and y are each independently selected from 0 to 3, preferably 0 or 1, e.g. 0;

R¹⁰ and R¹¹ are independently selected from hydrogen or C₁ to C₄ hydrocarbyl groups, e.g., C₁ to C₄ alkyl groups such as methyl, ethyl, preferably methyl, preferably at least one of R¹⁰ and R¹¹ is methyl, more preferably R¹⁰ and R¹¹ are both methyl;

o is 1 to 6, more preferably 2 to 4, e.g. 3; and

p is 1 to 6, more preferably 2 to 4, e.g. 3.

In case alcohols (B) are mixtures of compounds according to formulas (III) and (IV) the ratio (mol:mol) of compounds (III):(IV) is preferably within the range of from about 1:2 to about 10:1, more preferably within the range of from about 1:1 to about 5:1.

In case alcohols (B) are mixtures of compounds according to formulas (III) and (V) the ratio (mol:mol) of compounds (III):(V) is preferably within the range of from about 1:2 to about 10:1, more preferably within the range of from about 1:1 to about 5:1.

Non-limiting examples of alcohols (B) are diethylene glycol mono-butyl ether (butylcarbitol), monoethylene glycol mono-butyl ether, and SynFac 8009 available from Milliken Chemical Company of Spartanburg, S.C., which is represented by the following formula (VI):

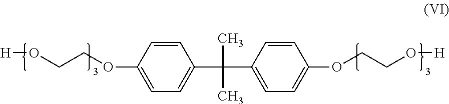

or mixtures thereof.

In one embodiment the blocked polyisocyanate is blocked polymeric methylene diisocyanate (PMDI). Polymeric methylene diisocyanate (PMDI) not including a blocking agent has the general formula (VII).

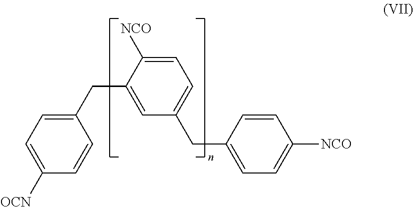

wherein n is usually 1 to 5, e.g., 1 to 3, such as 1.2.

Polymeric polyisocyanates, such as polymeric methylene diisocyanate (PMDI), may contain a mixture of compounds having a different number of repeating units, for example, a product mixture of molecules wherein the number of repeating units is 1 to 4. Thus, in the above example of PMDI, n may vary from 1 to 4 resulting in an average value of n, e.g., of about 1.2.

It is also possible that molecules are present that do not contain any repeating units, e.g., in the case of PMDI n would be zero, resulting in a diisocyanate.

In certain embodiments it may be desirable to reduce the amount of such diisocyanates as far as possible. However, in other embodiments the presence of a certain amount thereof may not be detrimental to the performance and properties of the resulting electrocoat compositions. In case of the latter using such a mixture may, thus, be preferable from an economic point of view.

In an exemplary embodiment, the blocked polyisocyanate comprising at least three blocked isocyanate groups makes up at least about 80 wt. % of the crosslinking component contemplated herein based on the solids content. In one embodiment the blocked polyisocyanate comprising at least three blocked isocyanate groups usually makes up at least about 90 wt. % of the crosslinking component based on the solids content.

In an exemplary embodiment, an electrocoat composition comprises:

i) the crosslinking component as contemplated herein;

ii) a binder resin; and

iii) optionally one or more pigments.

The binder resin preferably comprises a neutralized chain extended epoxy resin. Suitable epoxy resins include, for example, epoxy extended aromatic polyols, epoxy functional acrylic polymers, epoxy functional polyesters or combinations thereof. In some embodiments, the epoxy resin can be formed by the reaction product of a polyol with an epoxy compound, such as, for example, epichlorohydrin. The epoxy resin can have, on average, in the range of from 2 to 20 epoxy groups per molecule. In some embodiments, the epoxy resin can be the polyglycidyl ether of polyhydric phenols such as bisphenol A. In other embodiments, the epoxy resin can be the polyglycidyl ether of cyclic polyols. Suitable epoxy resins are known in the art and can be produced, for example, by the etherification of polyhydric phenols with epihalohydrin or dihalohydrin such as epichlorohydrin or dichlorohydrin in the presence of a base.

Suitable polyhydric phenols can include, for example, 2,2-bis(4-hydroxyphenyl)propane, bis(4-hydroxyphenyl)methane, 1,2-bis-(4-hydroxyphenyl)ethane, 2-methyl-1,1-bis-(4-hydroxyphenyl)propane, 2,2-bis-(4-hydroxy-3-tertiarybutylphenyl)propane, 1,1-bis-(4-hydroxyphenol)ethane, bis-(2-hydroxynaphthyl)methane and 1,5-dihydroxy naphthalene. Besides polyhydric phenols, other cyclic polyols can be used, such as, for example, 1,2-bis(hydroxymethyl)cyclohexane, 1,3-bis-(hydroxymethyl)cyclohexane, 1,4-bis-(hydroxymethyl)cyclohexane, 1,2 cyclohexane diol, 1,3 cyclohexane diol, 1,4-cyclohexane diol and hydrogenated bisphenol A.

The molecular weight of the epoxy resin, as measured as the weight per epoxy group (wpe), can be in the range of from about 300 to about 5,000. In some embodiments the weight per epoxy is in the range of from about 400 to about 3,000, e.g., from about 450 to about 2000. The epoxy resin preferably has two or more epoxy groups, which can then be chain extended with amines and then the amine groups can be neutralized with acid to form neutralized chain extended epoxy resin. Suitable amines that can be used include, for example, alkyl amines, dialkyl amines, diketimines, alkyl carbamate amines, hydroxyl containing amines and combinations thereof.

Examples of hydroxyl containing amines are alkanol amines, dialkanol amines, trialkanol amines, alkyl alkanol amines, arylalkanol amines and arylalkylalkanolamines containing from 2 to 18 carbon atoms in the aryl, alkyl and aryl chains. Typically useful amines can include, for example, ethanolamine, N-methyl-ethanolamine, diethanolamine, N-phenylethanolamine or a combination thereof.

The resulting epoxy amine resin can have reactive amine and hydroxyl groups.

In one embodiment the binder resin contains the structural element according to the following formula (VIII):

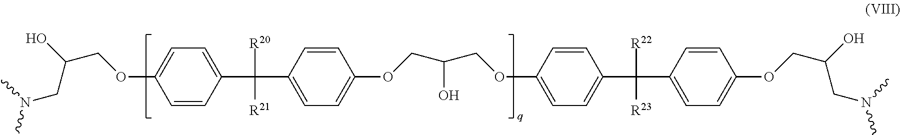

wherein
R²⁰, R²¹, R²² and R²³ are each independently selected from hydrogen or C₁ to C₄ hydrocarbyl groups, e.g., C₁ to C₄ alkyl groups such as methyl, ethyl, preferably methyl. In one embodiment at least one of R²⁰ and R²¹ and at least one of R²² and R²³ is a C₁ to C₄ alkyl group such as methyl, ethyl, preferably methyl. In another embodiment each of R²⁰, R²¹, R²² and R²³ are independently a C₁ to C₄ alkyl group such as methyl, ethyl, preferably methyl.

The further substituents on the nitrogen atoms which are not shown in the structural element according to formula (VIII) can have reactive amine and/or hydroxyl groups.

The concentration of the binder resin in the electrocoat composition can be in the range of from about 1 wt. % to about 60 wt. %, based on the solids content of the electrocoat composition.

The concentration of the crosslinking component is preferably within the range of about 20 to about 50 wt. % based on the solids content of the electrocoat composition.

Besides the binder resin and crosslinking component described above, the electrocoat composition can also contain one or more pigments which can be incorporated into the composition in the form of a pigment paste. The pigment paste can be prepared by grinding or dispersing the pigments into a grinding vehicle and other optional ingredients such as an anticrater additive, wetting agent, surfactant and/or defoamer, such as any of those disclosed herein. Any of the pigment grinding vehicles that are well known in the art can be used. Typically, grinding is done using conventional equipment known in the art such as, for example, an Eiger mill, Dynomill or sand mill. After grinding, the particle size of the pigment should be as small as practical. Generally, the particle size is about 6 to about 8 using a Hegman grinding gauge.

Pigments that can be used include, for example, titanium dioxide, barium sulfate, aluminum silicate, basic lead silicate, mixtures of silica and kaolinite, strontium chromate, carbon black, iron oxide, clay or a combination thereof. Pigments with high surface areas and oil absorbencies should be used judiciously because these can have an undesirable effect on coalescence and flow of the electrodeposited coating.

The weight ratio of pigment to the sum of binder resin and crosslinking component can be in the range of from about 0.5:1 to about 0.01:1, and in other embodiments the weight ratio of pigment to the sum of binder resin and crosslinking component can be in the range of from about 0.4:1 to about 0.1:1, and in further embodiments, the ratio can be in the range of from about 0.3:1 to about 0.11:1. Higher pigment to binder weight ratios have been found to adversely affect coalescence and flow.

The electrocoat compositions can contain optional ingredients such as catalysts, wetting agents, surfactants, plasticizers and defoamers. Suitable catalysts can include, for example, dialkyl tin carboxylates, such as, dibutyl tin dilaurate, dibutyl tin diacetate, dioctyl tin dicarboxylates and a combination thereof; bismuth catalysts, including, for example, bismuth oxide, bismuth trioxide, bismuth hydroxide, bismuth acetate, bismuth acetoacetonate, bismuth lactate, bismuth methane sulfate, bismuth dimethylpropionate, bismuth nitrate and a combination thereof. Combinations of any of the catalysts can also be used. Examples of surfactants and wetting agents include, for example, alkyl imidazolines such as those available from Ciba-Geigy Industrial Chemicals as AMINE® C., acetylenic alcohols available from Air Products and Chemicals as SURFYNOL® 104. Examples of useful plasticizers can be water immiscible materials such as ethylene or propylene oxide adducts of nonyl phenols or bisphenol A. These optional ingredients, when present, constitute in the range of from about 0.1 to about 20 percent by weight based on the solids content of the electrocoat composition. In case these optional ingredients are present, the sum of crosslinking component, binder resin and pigments, if present is about 99.9 to about 80 wt. % based on the solids content.

In an exemplary embodiment, the total amount of binder resin, crosslinking component, pigments, if present, and optional ingredients, if present is 100 wt. % based on the solids content of the electrocoat composition. In another exemplary embodiment, the solids content of the electrocoat composition is within the range of about 5 to about 50 wt. %, for example within the range of about 5 to about 30 wt. %, such as within the range of about 10 to about 30 wt. %.

The electrocoat composition contemplated herein preferably has a bake-off loss of about 12 wt. % or less when baked for 10 minutes at temperatures of up to 199° C. (390° F.).

The electrocoat composition contemplated herein can be deposited on a substrate and cured to provide a smooth durable layer of a coating composition that has good adhesion to a subsequently applied and cured layer of another coating composition. This can provide a substrate, especially a motor vehicle substrate with a durable chip resistant finish.

Preferred embodiments of the cross-linking component contemplated herein are also preferred embodiments of the electrocoat composition contemplated herein and vice versa.

Another embodiment of the current disclosure relates to a process for forming a layer of an electrocoat composition on the surface of a substrate comprising the following steps:

providing a bath of an electrocoat composition as described herein;

at least partially contacting the substrate with the electrocoat composition;

passing an electrical current through the substrate and the bath to apply a layer of the electrocoat composition onto the surface of the substrate;

removing the substrate from the electrocoat composition;

rinsing a surface of the substrate with deionized water; and

heating the applied layer of electrocoat composition to at least partially cure the layer of electrocoat composition.

Typical electrocoating conditions include about 200-270 volts and an immersion time sufficient to obtain a cured coating of about 10-40 micrometers. After electrodeposition, the coated substrate can be baked to a metal temperature of about 149° C. to about 182° C. for a sufficient time to cure the coating, typically about 20 minutes.

Curing of the applied layer of electrocoat composition can be done, in one embodiment, using direct heating of the applied layer of coating composition or, in another embodiment, by indirect heating of the applied layer of coating composition. Direct heating of the applied layer means heating of the substrate using flame as the heating source. In the case of direct heating, the combustion gases can directly contact the substrate to be cured. Indirect heating of the applied layer means heating of the applied layer using heat lamps, such as, for example, infra-red lamps, by resistive heating coils, or by warming air over a series of heat exchangers. With indirect heating methods, exhaust gases do not directly contact the substrate to be cured.

In one embodiment of the coating process, the substrate is at least partially immersed in the electrocoat composition. In a second embodiment, the entire substrate is immersed in the electrocoat composition.

Preferred embodiments of the cross-linking component contemplated herein and of the electrocoat composition contemplated herein are also preferred embodiments of the coating process contemplated herein and vice versa.

According to an exemplary embodiment, a substrate, e.g., metal such as steel, is coated with the electrocoat composition contemplated herein.

The substrate is preferably an automotive substrate.

Useful substrates for the electrocoat composition can include, for example, automobile bodies, any and all items manufactured and painted by automobile sub-suppliers, frame rails, trucks and truck bodies, beverage bodies, utility bodies, ready mix concrete delivery vehicle bodies, waste hauling vehicle bodies, fire and emergency vehicle bodies, as well as any potential attachments or components to such truck bodies, buses, farm and construction equipment, truck caps and covers, commercial trailers, consumer trailers, recreational vehicles, including for example, motor homes, campers, conversion vans, vans, pleasure vehicles, pleasure craft snow mobiles, all-terrain vehicles, personal watercraft, motorcycles, boats, and aircraft. The substrate can further include, for example, industrial and commercial new construction and maintenance thereof; amusement park equipment, marine surfaces; outdoor structures, such as bridges, towers; coil coating; railroad cars; machinery; OEM tools; signage; sporting goods; and sporting equipment.

The substrate may contain additional layers such as base coats and/or clear coats applied onto the layer on the substrate obtained by coating with the electrocoat composition described herein.

Thus, the substrate may contain a multi-layer coating comprising:

an electrocoated layer applied on the substrate using the electrocoat composition contemplated herein;

one or more base coats usually containing color- and/or effect-imparting pigments applied on the electrocoated layer;

a clear coat applied on the one or more base coats.

Any base coats and clear coats as usual and well-known in the art may be employed. Preferred embodiments of the cross-linking component of the electrocoat composition contemplated herein and of the coating process contemplated herein are also preferred embodiments of the substrate coated with the electrocoat composition as contemplated herein and vice versa.

In accordance with an exemplary embodiment, the use of a mixture of alcohols as a blocking agent for a polyisocyanate comprises:

from about 25 to about 75 mol % alcohols (A) comprising 4 carbon atoms or less; and

from about 25 to about 75 mol % alcohols (B) comprising 5 carbon atoms or more and containing one or more ether groups.

In one embodiment the polyisocyanate comprises at least three isocyanate groups.

In another exemplary embodiment, a mixture of alcohols for use as blocking agent for a polyisocyanate comprises:

from about 25 to about 75 mol % alcohols (A) comprising 4 carbon atoms or less; and from about 25 to about 75 mol % alcohols (B) comprising 5 carbon atoms or more and containing one or more ether groups.

In one embodiment the polyisocyanate comprises at least three isocyanate groups.

Preferred embodiments of the cross-linking component contemplated herein of the electrocoat composition of the coating process contemplated herein and of the substrate coated with the electrocoat composition as contemplated herein are also preferred embodiments of the use as contemplated herein and vice versa.

The various embodiments are further characterized by the following clauses:
1. A crosslinking component for electrocoat compositions comprising a blocked polyisocyanate, the blocked polyisocyanate comprising at least three blocked isocyanate groups, wherein a blocking agent for the blocked polyisocyanate comprises:

from about 25 to about 75 mol % alcohols (A) comprising 4 carbon atoms or less; and

from about 25 to about 75 mol % alcohols (B) comprising 5 carbon atoms or more and containing one or more ether groups.
2. The crosslinking component of clause 1, whereby the blocking agent comprises:

from about 35 to about 70 mol % alcohols (A); and

from about 30 to about 65 mol % alcohols (B).
3. The crosslinking component of clause 2, whereby the blocking agent comprises:

from about 40 to about 60 mol % alcohols (A); and

from about 27 to about 47 mol % alcohols (B);

wherein the remainder to 100 mol % alcohols comprises alcohols different from (A) and (B).
4. The crosslinking component of clause 2, whereby the blocking agent comprises:

from about 40 to about 60 mol % alcohols (A); and

from about 60 to about 40 mol % alcohols (B).
5. The cross-linking component of any one of the preceding clauses, wherein the blocked polyisocyanate comprising at least three blocked isocyanate groups makes up at least about 80 wt. % of the crosslinking component.
6. The cross-linking component of any one of the preceding clauses, wherein alcohols (B) are according to the general formula (I):

HO—R¹—O—R² (I)

wherein
R¹ is a C₁ to C₄-hydrocarbylene group, and
R² is a C₁ to C₅₀-hydrocarbyl group, optionally containing heteroatoms.
7. The cross-linking component of clause 6, wherein alcohols (B) are alcohols according to the following formulas (III), (IV) or mixtures thereof:

HO—[CH₂—CH₂—O]ₘ—R⁴ (III)

wherein
R⁴ is a C₁ to C₁₀-hydrocarbyl group free of heteroatoms; and
m is 1 to 10;

HO—[CH₂—CH₂—O]ₒ—R⁵—[O—CH₂—CH₂]ₚ—OH (IV)

wherein
R⁵ is a C₆ to C₂₅-hydrocarbyl group free of heteroatoms;
o is 1 to 10; and
p is 1 to 10.
8. The cross-linking component of clause 6 or 7, wherein alcohols (B) are selected from compounds according to formula (III) as defined in clause 7, from compounds according to the following formula (V):

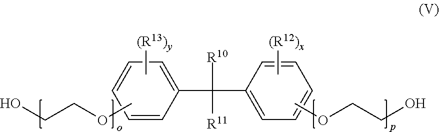

wherein
R¹³ and R¹⁴ are each independently selected from C₁ to C₄ hydrocarbyl groups;
x and y are each independently selected from 0 to 3;
R¹⁰ and R¹¹ are independently selected from hydrogen or C₁ to C₄ hydrocarbyl groups;
o is 1 to 6; and
p is 1 to 6;

or mixtures of compounds according to formula (III) and compounds according to formula (V).
9. The crosslinking component of any one of the preceding clauses, whereby the blocked polyisocyanate is blocked polymeric methylene diisocyanate (PMDI).
10. The crosslinking component of clause 9, whereby the polymeric methylene diisocyanate (PMDI) not including a blocking agent has the general formula (VII).

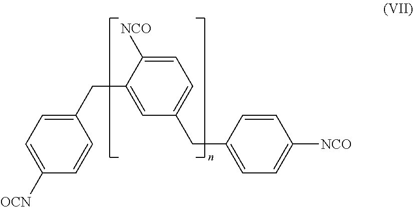

wherein n is 1 to 5.
11. An electrocoat composition comprising:
   i) the crosslinking component according to any one of the preceding clauses; and
   ii) a binder resin;
12. The electrocoat composition of clause 11 wherein the binder resin comprises a neutralized chain extended epoxy resin.
13. The electrocoat composition of clause 12 having a bake-off loss of about 12 wt. % or less when baked for 10 minutes at temperatures of up to 199° C. (390° F.).
14. A process for forming a layer of an electrocoat composition on the surface of a substrate comprising the steps of:
   providing a bath of an electrocoat composition according to clause 11, 12 or 13;
   at least partially contacting the substrate with the electrocoat composition;
   passing an electrical current through the substrate and the bath to apply a layer of the electrocoat composition onto the surface of the substrate;
   removing the substrate from the electrocoat composition;
   rinsing a surface of the substrate with deionized water; and heating the applied layer of electrocoat composition to at least partially cure the layer of electrocoat composition.
15. A substrate coated with the electrocoat composition according to any one of the preceding clauses 11 to 13.
16. An automotive substrate coated with the electrocoat composition according to any one of the preceding clauses 11 to 13.
17. A mixture of alcohols for use as blocking agent for a polyisocyanate comprising:
   from about 25 to about 75 mol % alcohols (A) comprising 4 carbon atoms or less; and
   from about 25 to about 75 mol % alcohols (B) comprising 5 carbon atoms or more and containing one or more ether groups.

The invention will be explained in more detail on the basis of the examples below. All parts and percentages are on a weight basis unless otherwise indicated.

### Examples

### Measurement Methods

The following measurement methods are used to evaluate the parameters given in the examples and claims.

NCO-Content

FTIR-spectra were recorded on a Thermo Mattison (Nicolet) Infrared Spectrophotometer. The presence of free isocyanate is indicated by a peak between 2330 cm⁻¹ and 2180 cm⁻¹. NCO-groups were considered absent in case no absorption between 2330 cm⁻¹ and 2180 cm⁻¹ was visible in the FTIR-spectrum.

Solids (Non-Volatiles)

The weight percentage of solids in the resin was determined by weighing approximately 1 g of sample in an aluminum dish with a diameter of 55 mm containing a paperclip. A small amount of acetone was added and a uniform layer was produced by stirring with the paperclip. Then, the dish was placed in an oven at about 105° C. (±1° C.) for about 1 hour and weighed again. The weight percentage of solids was calculated by using the Formula (VI):

% solids=100%×(residue weight/sample weight) (VI)

The solids were determined by measuring two samples. The given result is thus the average of two samples.

Gardner-Holdt (Bubble) Viscosity (G-H-Viscosity)

This method allows to quickly determine the kinematic viscosity of liquids such as resins and varnishes. Certified tubes from Byk Gardner are used for the measurement of the viscosity at room temperature.

Bake-Off-Loss of Electrocoat System

The bake-off-loss of an electrocoat composition is the % mass of electrocoat solids that will be lost between 105° C. and the curing time/temperature for the coating. The initial step is to deposit the coating on pre-weighed metal panel (ACT Bonderite 958/P90—3 in by 4 in). The residual water is removed by re-heating to 105° C. Finally, the panels are baked at the specified time and temperature. The overall weight loss is determined by the difference in mass:

% weight loss=(B−C)×(100)/(B−A), where

A=mass of panel,
B=mass of panel and electrocoat after 3 hours at 105° C.
C=mass of panel and cured electrocoat film

WPE (Weight Per Epoxy)

A titration method is employed to determine the weight per epoxy of electrocoat epoxy resin. The unreacted epoxy functionality is determined by the reaction with hydriodic acid generated in-situ by reaction of tetra-n-butylammonium iodide and perchloric acid. The consumption of perchloric acid is a measure of unreacted epoxy content present in epoxy resin.

Acid MEQ

The milli-equivalent of acid in an electrocoat composition is determined by direct titration of an electrocoat sample with potassium hydroxide using an automated titroprocessor (685 Dosimat, supplied by Metrohm). The sample weight is corrected for % non-volatile so the acid value is reported as MEQ/100 grams solids.

Particle Size (PS)

The test method uses the scattering of yellow light in a spectrophotometer to determine the approximate particle size of a cathodic resin emulsion. The wt. % solids of the resin, such as the cathodic resin, to be measured must be determined as outlined above prior to determining the particle size. The apparatus used for this determination is a Spectronic 21 spectrophotometer. The wave length used for the measurement is 580 nm.

Conductivity

The conductivity has been determined using a YSI Model 3401 conductivity probe with cell constants of K=1.0 cm-1 and a YSI Model 3100 or Model 35 conductivity bridge. The calibration solution had a conductivity of 1000 microSiemens/cm.

### Examples

### Used Materials

| | |
|---|---|
| Mondur MR Light | aromatic polymeric isocyanate based on diphenylmethane-diisocyanate (MDI), |
| | supplied by Bayer MaterialScience |
| DBTDL | dibutyl-tin-dilaureate |
| MIBK | methyl-isobutylketone |
| TMP | trimethylolpropane |
| Butylcellosolve | CH₃— (CH₂)₃—O— (CH₂)₂— OH |
| SynFac 8009 | ethoxylated bisphenol, supplied by Milliken Chemical Co. |
| | 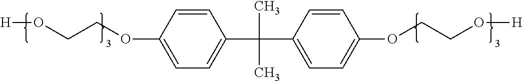 |
| Epon 828 | 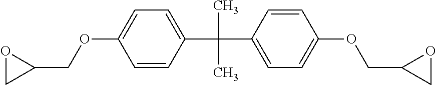 [SMILES: CC(C)(c1ccc(OCC2CO2)cc1)c1ccc(OCC2CO2)cc1] |
| TPPI | triphenyl phosphonium iodide |
| MEOA | methylethanol amine |
| Diketimine | 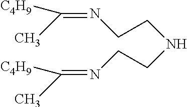 |
| DIW | de-ionised water |
| MSA | methanesulfonic acid |
| FCA | flow control agent, blend of 40% butylcellosolve and 60% methyl dibasic esters from |
| | short-chain acids such as adipic acid, glutaric acid, and succinic acid and/or propylene |
| | glycol phenyl ether |
| SynFac 8334 | 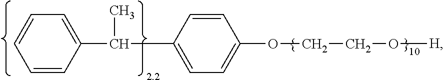 |
| | supplied by Milliken Chemical Co. |

Crosslinking Components

CL-R (Reference)

TABLE 1

| Charge | | Equivalent | Weight [g] |
|---|---|---|---|
| no. | component | ratio | including volatiles |
| 1 | Mondur MR Light | 1.000 | 1444.9 |
| 2 | DBTDL | | 0.3 |
| 3 | MIBK | | 222.0 |
| 4 | TMP | 0.125 | 60.3 |
| 5 | Butylcarbitol | 0.875 | 1552.4 |
| 6 | Butanol | | 36.6 |
| 7 | MIBK | | 741.4 |
| total | | | 4077 |

Charges no. 1, 2 and 3 were introduced into a reactor. After turning on the nitrogen blanket the temperature was raised to 82° C. (180° F.). Charges no. 4 and 5 were combined and added to the reactor via a dropping funnel. The dropping rate was adjusted to maintain the reaction temperature between 104° C. (220° F.) and 116° C. (240° F.). After completion of the addition the temperature was maintained at 116° C. (240° F.) for 2 hours. Thereafter the presence of NCO-groups was determined by IR-spectroscopy and the reaction was maintained at 116° C. (240° F.) until NCO-groups were absent. Thereafter charge no. 7 was added and the resulting mixture stirred for 30 min, cooled and removed from the reactor.

The final solids content was 75 wt. % and the G-H-viscosity was X-Y and the bake-off-loss based on the crosslinker solids was 50 wt. %.

### CL-A (Exemplary Embodiment)

TABLE 2

| Charge | | Equivalent | Weight [g] |
|---|---|---|---|
| no. | Component | ratio | including volatiles |
| 1 | MIBK | | 210.5 |
| 2 | Mondur MR Light | 1.000 | 1354.5 |
| 3 | DBTDL | | 0.27 |
| 4 | Ethanol | 0.480 | 223.3 |
| 5 | Butylcellosolve | 0.420 | 500.9 |
| 6 | SynFac 8009 | 0.100 | 250.0 |
| 7 | Butanol | | 34.2 |
| 8 | MIBK | | 531.3 |
| total | | | 3105 |

Charges no. 1, 2 and 3 were introduced into a reactor. After turning on the nitrogen blanket the temperature was raised to 82° C. (180° F.). Charges no. 4, 5 and 6 were combined and added to the reactor via a dropping funnel. The dropping rate was adjusted to maintain the reaction temperature between 104° C. (220° F.) and 116° C. (240° F.). After completion of the addition the temperature was maintained at 116° C. (240° F.) for 2 hours. Thereafter the presence of NCO-groups was determined by IR-spectroscopy and the reaction was maintained at 116° C. (240° F.) until NCO-groups were absent. Thereafter charges no. 7 and 8 were added and the resulting mixture was stirred for 30 minutes, cooled and removed from the reactor.

The final solids content was 75 wt. % and the G-H-viscosity was X-Y and the bake-off-loss based on the crosslinker solids was 31 wt. %.

### CL-B (Exemplary Embodiment)

TABLE 3

| Charge | | Equivalent | Weight [g] |
|---|---|---|---|
| no. | Component | ratio | including volatiles |
| 1 | MIBK | | 334.6 |
| 2 | Mondur MR Light | 1.000 | 1334.3 |
| 3 | DBTDL | | 0.27 |
| 4 | Ethanol | 0.500 | 234.6 |
| 5 | Butylcarbitol | 0.350 | 568.3 |
| 6 | SynFac 8009 | 0.150 | 372.0 |
| 7 | Butanol | | 33.5 |
| 8 | MIBK | | 468.11 |
| total | | | 3346 |

Charges no. 1, 2 and 3 were introduced into a reactor. After turning on the nitrogen blanket the temperature was raised to 82° C. (180° F.). Charges no. 4, 5 and 6 were combined and added to the reactor via a dropping funnel. The dropping rate was adjusted to maintain the reaction temperature between 104° C. (220° F.) and 116° C. (240° F.). After completion of the addition the temperature was maintained at 116° C. (240° F.) for 2 hours. Thereafter the presence of NCO-groups was determined by IR-spectroscopy and the reaction was maintained at 116° C. (240° F.) until NCO-groups were absent. Thereafter charges no. 7 and 8 were added and the resulting mixture was stirred for 30 minutes, cooled and removed from the reactor.

The final solids content was 75 wt. % and the G-H-viscosity was X-Y and the bake-off-loss based on the crosslinker solids was 32 wt. %.

### CL-C (Exemplary Embodiment)

TABLE 4

| Charge | | Equivalent | Weight [g] |
|---|---|---|---|
| no. | Component | ratio | including volatiles |
| 1 | MIBK | | 272.9 |
| 2 | Mondur MR Light | 1.000 | 1320.0 |
| 3 | DBTDL | | 0.26 |
| 4 | TMP | 0.130 | 55.9 |
| 5 | Ethanol | 0.500 | 233.4 |
| 6 | Butylcellosolve | 0.370 | 437.8 |
| 7 | Butanol | | 19.1 |
| 8 | MIBK | | 390.03 |
| total | | | 2729.3 |

Charges no. 1, 2 and 3 were introduced into a reactor. After turning on the nitrogen blanket the temperature was raised to 82° C. (180° F.). Charges no. 4, 5 and 6 were combined and added to the reactor via a dropping funnel. The dropping rate was adjusted to maintain the reaction temperature between 104° C. (220° F.) and 116° C. (240° F.). After completion of the addition the temperature was maintained at 116° C. (240° F.) for 2 hours. Thereafter the presence of NCO-groups was determined by IR-spectroscopy and the reaction was maintained at 116° C. (240° F.) until NCO-groups were absent. Thereafter charges no. 7 and 8 were added and the resulting mixture was stirred for 30 minutes, cooled and removed from the reactor.

The final solids content was 75 wt. % and the G-H-viscosity was Z-Z1 and the bake-off-loss based on the crosslinker solids was 32 wt. %.

Emulsions with Crosslinker (EC)

### EC-R (Reference)

TABLE 5

| Charge | | Weight [g] | Non-volatiles |
|---|---|---|---|
| no. | Component | including volatiles | [g] |
| 1 | Epon 828 | 550.9 | 550.9 |
| 2 | Bisphenol A | 236.9 | 236.9 |
| 3 | Xylene | 20.2 | |
| 4 | TPPI | 0.6 | |
| total | | 808.6 | |
| 5 | Synfac 8009 | 108.8 | 108.8 |
| 6 | CL-R | 787.6 | 590.7 |
| 7 | MEOA | 48.4 | 48.4 |
| 8 | Diketimine | 67.6 | 18.7 |
| Total 1-8 | | 1821.0 | 1554.4 |
| 9 | DIW | 1295.8 | |
| 10 | MSA | 65.1 | 45.6 |
| 11 | DIW | 801.1 | |
| 12 | 5% Nitric acid | 17.0 | |
| Total 1-12 | | 4000 | 1600 |

The reactor was purged with nitrogen and charges no. 1 to 4 were introduced into the reactor under nitrogen. Thereafter the temperature was raised to 145° C. (290° F.) at which an exothermic reaction occurred. After the exothermic reaction the temperature was set to 160° C. (320° F.) and maintained for one hour. The WPE was determined and the heating at 160° C. (320° F.) was continued until the WPE (solution) was in the range of 949±25%. Thereafter the temperature was set to 107° C. (225° F.) and charge no. 5 was added and mixed for 10 minutes whereupon the temperature was set to 150° C. (300° F.) and charge no. 6 (crosslinker) was added. The resulting mixture was stirred for 20 minutes.

After cooling to 110° C. (230° F.), charge no. 7 was added and mixed for 10 minutes and charge no. 8 was added such that the temperature did not exceed 125° C. (260° F.). Then the temperature was set to 120° C. (250° F.) and maintained for 1 hour.

The resulting product was transferred to a thin tank containing charges no. 9 and 10 and mixed for 30 minutes. Thereafter charge 11 was added and mixing was continued for 30 minutes. Finally charge no. 12 was added.

### EC-A (Exemplary Embodiment)

TABLE 6

| Charge | | Weight [g] | Non-volatiles |
|---|---|---|---|
| no. | Component | including volatiles | [g] |
| 1 | Epon 828 | 1063.6 | 1063.6 |
| 2 | Bisphenol A | 431.8 | 431.8 |
| 3 | Xylene | 38.3 | |
| 4 | TPPI | — | — |
| Total | | 1533.7 | 1495.4 |
| 5 | Synfac 8009 | 278.8 | 278.8 |
| 6 | CL-A | 1569.5 | 1177.1 |
| 7 | MEOA | 109.0 | 109.0 |
| 8 | Diketimine | 134.9 | 37.4 |
| 8A | FCA | 46.5 | |
| Total 1-8 | | 3672.4 | 3097.7 |
| 9 | MSA | 146.2 | 102.3 |
| 10 | DIW | 2185.6 | |
| 11 | Bismuth trioxide | 28.8 | 28.8 |
| 12 | DIW | 2010.6 | |
| 13 | 5% Nitric acid | 28.4 | |
| Total 1-13 | | 8072 | 3228.8 |

Charges no. 9, 10 and 11 were transferred to a thin tank and the bismuth trioxide (charge 11) was dissolved. This tank was used as further described below.

A reactor was purged with nitrogen and charges no. 1 to 4 were introduced into the reactor under nitrogen. Thereafter the temperature was raised to 145° C. (290° F.) at which an exothermic reaction occurred with the temperature rising to 216° C. (420° F.). After the exothermic reaction the temperature was set to 160° C. (320° F.) and maintained for one hour. The WPE was determined and the heating at 160° C. (320° F.) was continued until the WPE was in the range of 820±1%.

Thereafter the temperature was set to 107° C. (225° F.) and charge no. 5 was added and mixed for 10 minutes whereupon the temperature was set to 150° C. (300° F.) and charge no. 6 (crosslinker) was added. The resulting mixture was stirred for 20 minutes.

After cooling to 110° C. (230° F.), charge no. 7 was added and mixed for 10 minutes and charge no. 8 was added such that the temperature did not exceed 125° C. (260° F.). Then the temperature was set to 120° C. (250° F.) and maintained for 1 hour. Charge no. 8A was added and stirring continued for 20 minutes.

The resulting product was transferred to the thin tank containing charges no. 9, 10 and 11 and mixed for 30 minutes. Thereafter charge no. 12 was added and mixing was continued for 30 minutes. Finally charge no. 13 was added.

The resulting properties are shown in Table 9 below.

### EC-B (Exemplary Embodiment)

TABLE 7

| Charge | | Weight [g] | Non-volatiles |
|---|---|---|---|
| no. | Component | including volatiles | [g] |
| 1 | Epon 828 | 1063.6 | 1063.6 |
| 2 | Bisphenol A | 431.8 | 431.8 |
| 3 | Xylene | 38.3 | |
| 4 | TPPI | 1.1 | |
| Total | | 1534.8 | 1495.4 |
| 5 | Synfac 8009 | 278.8 | 278.8 |
| 6 | CL-B | 1569.5 | 1177.1 |
| 7 | MEOA | 109.0 | 109.0 |
| 8 | Diketimine | 134.9 | 37.4 |
| 8A | FCA | 48.4 | |
| Total 1-8 | | 3675.4 | 3097.7 |
| 9 | MSA | 146.2 | 102.3 |
| 10 | DIW | 2208.3 | |
| 11 | Bismuth trioxide | 28.8 | 28.8 |
| 12 | DIW | 2033.3 | |
| 13 | 5% Nitric acid | 28.4 | |
| Total 1-13 | | 8120.4 | 3228.8 |

Charges no. 9, 10 and 11 were transferred to a thin tank and the bismuth trioxide (charge 11) was dissolved. This tank was used as further described below.

A reactor was purged with nitrogen and charges no. 1 to 4 were introduced into the reactor under nitrogen. Thereafter the temperature was raised to 145° C. (290° F.) at which an exothermic reaction occurred with the temperature rising to 216° C. (420° F.). After the exothermic reaction the temperature was set to 160° C. (320° F.) and maintained for one hour. The WPE was determined and the heating at 160° C. (320° F.) was continued until the WPE (solution) was in the range of 821±25%.

Thereafter the temperature was set to 107° C. (225° F.) and charge no. 5 was added and mixed for 10 minutes whereupon the temperature was set to 150° C. (300° F.) and charge no. 6 (crosslinker) was added. The resulting mixture was stirred for 20 minutes.

After cooling to 110° C. (230° F.), charge no. 7 was added and mixed for 10 minutes and charge no. 8 was added such that the temperature did not exceed 125° C. (260° F.). Then the temperature was set to 120° C. (250° F.) and maintained for 1 hour. Charge no. 8A was added and stirring continued for 20 minutes.

The resulting product was transferred to the thin tank containing charges no. 9, 10 and 11 and mixed for 30 minutes. Thereafter charge no. 12 was added and mixing continued for 30 minutes. Finally charge no. 13 was added.

The resulting properties are shown in Table 9 below.

### EC-C (Exemplary Embodiment)

TABLE 8

| Charge | | Weight [g] | Non-volatiles |
|---|---|---|---|
| no. | Component | including volatiles | [g] |
| 1 | Epon 828 | 1063.6 | 1063.6 |
| 2 | Bisphenol A | 431.8 | 431.8 |
| 3 | Xylene | 38.3 | |
| 4 | TPPI | 1.1 | |
| Total | | 1534.8 | 1495.4 |
| 5 | Synfac 8009 | 278.8 | 278.8 |
| 6 | CL-B | 1569.5 | 1177.1 |
| 7 | MEOA | 109.0 | 109.0 |
| 8 | Diketimine | 134.9 | 37.4 |
| 8A | FCA | 48.4 | |
| Total 1-8 | | 3675.4 | 3097.7 |
| 9 | MSA | 146.2 | 102.3 |
| 10 | DIW | 2208.3 | |
| 11 | Bismuth trioxide | 28.8 | 28.8 |
| 12 | DIW | 2033.3 | |
| 13 | 5% Nitric acid | 28.4 | |
| Total 1-13 | | 8120.4 | 3228.8 |

Charges no. 9, 10 and 11 were transferred to a thin tank and the bismuth trioxide (charge no. 11) was dissolved. This tank is used as further described below.

The reactor was purged with nitrogen and charges no. 1 to 4 were introduced into the reactor under nitrogen. Thereafter the temperature was raised to 145° C. (290° F.) at which an exothermic reaction occurred with the temperature rising to 216° C. (420° F.). After the exothermic reaction the temperature was set to 160° C. (320° F.) and maintained for one hour. The WPE was determined and the heating at 160° C. (320° F.) continued until the WPE was in the range of 821±1%.

Thereafter the temperature was set to 107° C. (225° F.) and charge no. 5 was added and mixed for 10 minutes whereupon the temperature was set to 150° C. (300° F.) and charge no. 6 (crosslinker) was added. The resulting mixture was stirred for 20 minutes.

After cooling to 110° C. (230° F.), charge no. 7 was added and mixed for 10 minutes and charge no. 8 was added such that the temperature did not exceed 125° C. (260° F.). Then the temperature was set to 120° C. (250° F.) and maintained for 1 hour. Charge no. 8A was added and stirring continued for 20 minutes.

The resulting product was transferred to the thin tank containing charges no. 9, 10 and 11 and mixed for 30 minutes. Thereafter charge no. 12 was added and mixing continued for 30 minutes. Finally charge no 13 was added.

The resulting properties are shown in Table 9 below.

TABLE 9

| | EC-R | EC-A | EC-B | EC-C |
|---|---|---|---|---|
| WPE (solution) | 949 | 826 | 821 | 821 |
| Acid MEQ | 29.6 | 32.83 | 32.99 | 32.99 |
| PS | 750 | 760 | 820 | 850 |
| pH | 6.43 | 6.35 | 6.32 | 6.50 |
| Solids content | 40 | 40.34 | 40 | 40 |
| [wt. %] | | | | |
| Conductivity | 3340 | 3035 | 3186 | 2922 |

Bake-Off Loss

The bake-off loss of EC-R, EC-A and EC-B were investigated at different temperatures. The baking time was 10 minutes in each case. The results are given in the following table.

TABLE 10

| | Bake-off loss [wt. %] | | |
|---|---|---|---|
| Temperature | EC-R | EC-A | EC-B |
| 160° C. (320° F.) | 7.7 | 5.1 | 5.9 |
| 165° C. (330° F.) | 9.9 | 6.3 | 6.8 |
| 182° C. (360° F.) | 14.1 | 9.2 | 9.3 |
| 199° C. (390° F.) | 15.3 | 10.0 | 10.7 |

4-Box Throwpower Test

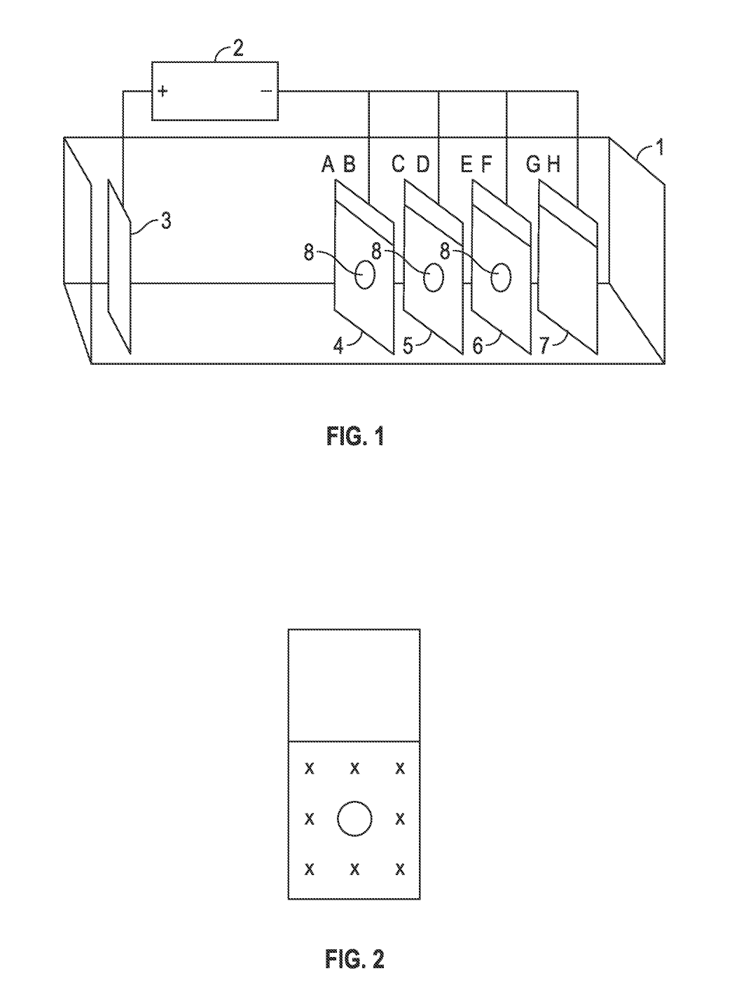

A 4-box throwpower apparatus described by Shinto as depicted in FIG. 1 was used. The reference numbers of FIG. 1 are assigned as follows:
1 box for electrocoat bath. As used in this experiment, the bath had a width of 190 mm and a depth of 100 mm;
2 DC power source;
3 anode;
4, 5, 6, 7 cathodes. As used in this experiment, the cathodes had a depth of 70 mm;
8 holes in cathodes 4, 5 and 6. In this experiment, the holes had a diameter of 8 mm and the distance from the center of the holes to the bottom of the respective cathode was 50 mm;
A, C, E, G sides of cathodes 4, 5, 6 and 7 facing the anode; and
B, D, F, H sides of cathodes 4, 5, 6 and 7 not facing the anode.

The height of the electrocoat bath was 90 mm. The distance between the anode and electrode 4 was 90 mm and the distance between electrode 4 and 5, 5 and 6, and 6 and 7 was 20 mm each.

The box was filled with the electrocoat composition to be tested and a voltage of 200 to 280 V was applied for three minutes. Testing throw in this setup was done with a 30″ ramp and 150″ dwell. The temperature was 32° C. (90° F.). Thereafter the panels were rinsed and baked at 165° C. for 10 minutes metal temperature. Then the film thicknesses on face A and face G were determined on the eight spots indicated by the “X's” in FIG. 2 and the average thereof was calculated.

The throwpower (% G/A) was defined as follows:

$$\text{Throwpower} ( \% G / A ) = \frac{G - face film thickness}{A - face film thickness} \cdot 100$$

The following compositions were used as electrocoat compositions for the 4-box throwpower test.

### RE (Reference)

TABLE 11

| | Solids | Resin | Weight including |
|---|---|---|---|
| Component | [wt. %] | Solids [g] | non-solids [g] |
| EC-R | 40.0 | 596.7 | 1492 |
| Anticrater | 32.1 | 66.4 | 207 |
| additives | | | |
| DIW | | | 2027 |
| PP-1 | 50.0 | 32.6^{a)} | 274 |
| Total | | 695.7 | 4000 |

^{a)}+104.3 g pigment solids

PP-1 was prepared by adding 26.470 g of de-ionized water to 14.611 g of the organic tertiary amine acid salt of Example I of U.S. Pat. No. 4,081,343 (58 wt. % solids, 8.474 g solids). To the resulting mixture 0.951 g SynFac 8334 (cf. above), 4.611 g bismuth intermediate paste (35. wt. % total solids, 0.879 resin solids) and 12.422 g of dibutyl-tin oxide (DBTO) paste (44.3 wt. % total solids, 1.612 resin solids) were added under stirring and stirring was continued for 30 minutes. To the resulting mixture 11.988 g TiO₂ (100 wt. % solids, TI-PURE R-900 supplied by DuPont Titanium Technologies), 16.264 g barium sulphate (100 wt. % solids, Blanc Fixe F, supplied by Sachtleben), 4.895 aluminum silicate (99 wt. % solids, ASP 200, supplied by BASF) and 0.359 Printex 300 (100 wt. % solids, furnace carbon black, supplied by Orion Engineered Carbons S.A.) were added under stirring and stirring was continued for 30 minutes. Finally 7.429 g de-ionized water was added. The resulting mixture had a resin solids content of 11.916 wt. % and a pigment content of 38.084 wt. %.

The bismuth intermediate paste is a mixture of 27.45 g (58 wt. % solids) of the organic tertiary amine acid salt of Example I of U.S. Pat. No. 4,081,343, 5.61 g (56 wt. % solids) of lactic acid and 15.94 g bismuth trioxide in 51 g water.

The DBTO paste is a mixture of 22.4 g (58 wt. % solids) of the organic tertiary amine acid salt of Example I of U.S. Pat. No. 4,081,343, and 31.32 g DBTO in 46.28 g water.

IE-A

TABLE 12

| | Solids | Resin | Weight including |
|---|---|---|---|
| Component | [wt. %] | Solids [g] | non-solids [g] |
| EC-A | 40.0 | 596.7 | 1492 |
| Anticrater | 32.1 | 66.4 | 207 |
| additive | | | |
| DIW | | | 2027 |
| PP-2 | 50.0 | 32.6^{a)} | 274 |
| Total | | | 4000 |

^{a)}+104.3 g pigment solids

PP-2 was prepared by adding 34.073 g of de-ionized water to 20.284 g of the organic tertiary amine acid salt of Example I of U.S. Pat. No. 4,081,343 (58 wt. % solids, 11.765 g). To the resulting mixture, 0.229 g of Printex 300 (100 wt. % solids, furnace carbon black, supplied by Orion Engineered Carbons S.A.), 30.359 g Silitin Z86 (100 wt. % solids, mixture of silica and kaolinite, supplied by Hoffmann Mineral) and 7.647 g TiO₂ (TI-PURE R-900 supplied by DuPont Titanium Technologies) were added while stirring for 15 minutes. Finally 7.407 g de-ionized water was added. The resulting mixture had a resin solids content of 11.765 wt. % and a pigment content of 38.235 wt. %

IE-B

IE-B was prepared as IE-A except that EC-B instead of EC-A was used.

IE-C

IE-C was prepared as IE-A except that EC-C instead of EC-A was used.

TABLE 13

| | RE | IE-A | IE-B | IE-C |
|---|---|---|---|---|
| throwpower (% G/A) | 54 | 67 | 65 | 66 |

Thus, the resins contemplated herein provide improved throwpower and, thus, the coating of recessed areas is improved.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A crosslinking component for electrocoat compositions, the crosslinking component comprising a blocked polyisocyanate, the blocked polyisocyanate comprising at least three blocked isocyanate groups, wherein a blocking agent for the blocked polyisocyanate comprises:
from about 25 to about 75 mol % alcohols (A) comprising 4 carbon atoms or less; and
from about 25 to about 75 mol % alcohols (B) comprising 5 carbon atoms or more and containing one or more ether groups.

2. The crosslinking component of claim 1, wherein the blocking agent comprises:
from about 35 to about 70 mol % alcohols (A); and
from about 30 to about 65 mol % alcohols (B).

3. The crosslinking component of claim 2, wherein the blocking agent comprises:
from about 40 to about 60 mol % alcohols (A); and
from about 27 to about 47 mol % alcohols (B);
the remainder to 100 mol % alcohols comprising alcohols different from (A) and (B).

4. The crosslinking component of claim 2, wherein the blocking agent comprises:
from about 40 to about 60 mol % alcohols (A); and
from about 60 to about 40 mol % alcohols (B).

5. The cross-linking component of claim 1, wherein the blocked polyisocyanate comprising at least three blocked isocyanate groups makes up at least about 80 wt. % of the crosslinking component.

6. The cross-linking component of claim 1, wherein alcohols (B) are according to the general formula (I):
HO—R¹—O—R² (I)
wherein:
R¹ is a C₁ to C₄-hydrocarbylene group, and
R² is a C₁ to C₅₀-hydrocarbyl group, optionally containing heteroatoms.

7. The cross-linking component of claim 6, wherein alcohols (B) are alcohols according to the following formulas (III), (IV) or mixtures thereof:
HO—[CH₂—CH₂—O]ₘ—R⁴ (III)
wherein:
R⁴ is a C₁ to C₁₀-hydrocarbyl group free of heteroatoms; and
m is 1 to 10;
HO—[CH₂—CH₂—O]ₒ—R⁵—[O—CH₂—CH₂]ₚ—OH (IV)
wherein:
R⁵ is a C₆ to C₂₅-hydrocarbyl group free of heteroatoms;
o is 1 to 10; and
p is 1 to 10.

8. The cross-linking component of claim 6, wherein alcohols (B) are selected from compounds according to formula (III), (V), or mixtures thereof:
HO—[CH₂—CH₂—O]ₘ—R⁴ (III)
wherein:
R⁴ is a C₁ to C₁₀-hydrocarbyl group free of heteroatoms; and
m is 1 to 10; 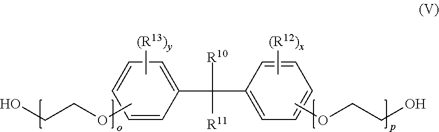
wherein
R¹³ and R¹⁴ are each independently selected from C₁ to C₄ hydrocarbyl groups;
x and y are each independently selected from 0 to 3;
R¹⁰ and R¹¹ are independently selected from hydrogen or C₁ to C₄ hydrocarbyl groups;
o is 1 to 6; and
p is 1 to 6.

9. The crosslinking component of claim 1, wherein the blocked polyisocyanate is blocked polymeric methylene diisocyanate (PMDI).

10. The crosslinking component of claim 9, wherein the polymeric methylene diisocyanate (PMDI) not including a blocking agent has the formula (VII): 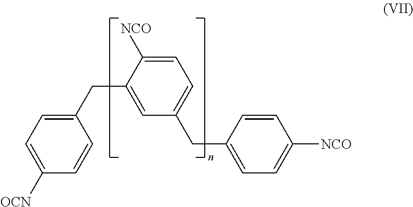
wherein n is 1 to 5.

11. An electrocoat composition comprising:
a crosslinking component comprising a blocked polyisocyanate, the blocked polyisocyanate comprising at least three blocked isocyanate groups, wherein a blocking agent for the blocked polyisocyanate comprises:
from about 25 to about 75 mol % alcohols (A) comprising 4 carbon atoms or less; and
from about 25 to about 75 mol % alcohols (B) comprising 5 carbon atoms or more and containing one or more ether groups; and
a binder resin.

12. The electrocoat composition of claim 11, wherein the binder resin comprises a neutralized chain extended epoxy resin.

13. The electrocoat composition of claim 11, having a bake-off loss of 12 wt. % or less when baked for 10 minutes at temperatures of up to 199° C. (390° F.).

14. The electrocoat composition of claim 11, wherein alcohols (B) are according to the general formula (I):
HO—R¹—O—R² (I)
wherein:
R¹ is a C₁ to C₄-hydrocarbylene group, and
R² is a C₁ to C₅₀-hydrocarbyl group, optionally containing heteroatoms.

15. The electrocoat composition of claim 14, wherein alcohols (B) are alcohols according to the following formulas (III), (IV) or mixtures thereof:
HO—[CH₂—CH₂—O]ₘ—R⁴ (III)
wherein:
R⁴ is a C₁ to C₁₀-hydrocarbyl group free of heteroatoms; and
m is 1 to 10;
HO—[CH₂—CH₂—O]ₒ—R⁵—[O—CH₂—CH₂]ₚ—OH (IV)
wherein:
R⁵ is a C₆ to C₂₅-hydrocarbyl group free of heteroatoms;
o is 1 to 10; and
p is 1 to 10.

16. The electrocoat composition of claim 14, wherein alcohols (B) are selected from compounds according to formula (III), (V), or mixtures thereof:
HO—[CH₂—CH₂—O]ₘ—R⁴ (III)
wherein:
R⁴ is a C₁ to C₁₀-hydrocarbyl group free of heteroatoms; and
m is 1 to 10; 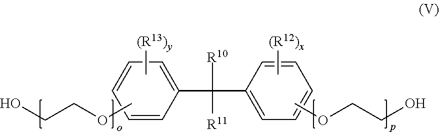
wherein
R¹³ and R¹⁴ are each independently selected from C₁ to C₄ hydrocarbyl groups;
x and y are each independently selected from 0 to 3;
R¹⁰ and R¹¹ are independently selected from hydrogen or C₁ to C₄ hydrocarbyl groups;
o is 1 to 6; and
p is 1 to 6.

17. The electrocoat composition of claim 11, wherein the blocked polyisocyanate is blocked polymeric methylene diisocyanate (PMDI).

18. The electrocoat composition of claim 17, wherein the polymeric methylene diisocyanate (PMDI) not including a blocking agent has the formula (VII): 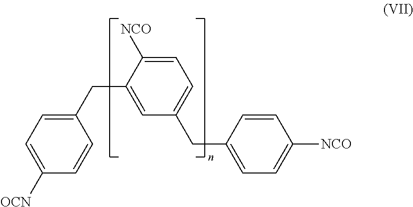
wherein n is 1 to 5.

19. A process for forming a layer of an electrocoat composition on a surface of a substrate, the process comprising the steps of:
providing a bath of an electrocoat composition, the electro electrocoat composition comprising:
a crosslinking component comprising a blocked polyisocyanate, the blocked polyisocyanate comprising at least three blocked isocyanate groups, wherein a blocking agent for the blocked polyisocyanate comprises:
from about 25 to about 75 mol % alcohols (A) comprising 4 carbon atoms or less; and
from about 25 to about 75 mol % alcohols (B) comprising 5 carbon atoms or more and containing one or more ether groups; and
a binder resin;
at least partially contacting the substrate with the electrocoat composition;
passing an electrical current through the substrate and the bath to apply a layer of the electrocoat composition onto the surface of the substrate;
removing the substrate from the electrocoat composition;
rinsing the surface of the substrate with deionized water; and
heating the layer of the electrocoat composition to at least partially cure the layer of the electrocoat composition.

20. The process of claim 19, wherein the blocked polyisocyanate comprising at least three blocked isocyanate groups makes up at least about 80 wt. % of the crosslinking component.
